(19) United States
(12) Patent Application Publication
(10) Pub. No.: US 2004/0263991 A1
(43) Pub. Date: Dec. 30, 2004

(54) Astigmatic correction in LCoS video projection color management architectures using shared plate beam splitters

(75) Inventor: Michael G. Robinson, Boulder, CO (US)

Correspondence Address: BAKER & MCKENZIE, PATENT DEPARTMENT, 2001 ROSS AVENUE, SUITE 2300, DALLAS, TX, 75201, US

(73) Assignee: ColorLink, Inc.

(21) Appl. No.: 10/844,053

(22) Filed: May 12, 2004

Related U.S. Application Data
(60) Provisional application No. 60/470,158, filed on May 13, 2003.

(51) Int. Cl. G02B 26/08; G02B 27/10; G02B 27/14

(52) U.S. Cl. 359/634

(57) ABSTRACT

Disclosed is a technology that corrects astigmatism introduced by crossing beam splitting/combining plates. This technology may be used in the context of video projection systems, whereby the plates may be used for combining and/or splitting beams between two or more light modulating panels. In one embodiment, a system is provided for projecting an optical image, where the system includes a lens configured to receive and focus light rays to project the image. The system also includes a first beam splitting/combining plate that refracts light rays passing therethrough, where the refracting creates pluralities of light rays having corresponding optical paths causing each of the pluralities to be focused on corresponding focal planes by the lens. In addition, the system also includes a second beam splitting/combining plate configured to receive the pluralities of rays from the first beam splitting/combining plate, where the second beam splitting/combining plate is oriented with respect to the first beam splitting/combining plate so as to compensate the corresponding optical paths of the pluralities of rays such that each of the pluralities are focused on substantially the same focal plane by the lens.

### CROSS-REFERENCE TO RELATED APPLICATION

This Application claims the benefit of U.S. Provisional Application Ser. No. 60/470,158, filed on May 13, 2003, and entitled “Astigmatic Correction in LCoS Video Projection Color Management Architectures Using Shared Plate Beam Splitters,” which is commonly assigned with the present application and incorporated herein by reference for all purposes.

### TECHNICAL FIELD

Disclosed embodiments herein relate generally to multiple panel color management architectures for Liquid Crystal on Silicon (LCoS) video projection systems. Specifically it relates to the efficient use of two plate-beamsplitters tilted about orthogonal axes relative to each other to correct for astigmatic aberrations.

### BACKGROUND

ColorLink, Inc., the assignee of the present disclosure, and others have developed and even patented several architectures that use a single polarizing beam splitter (PBS) for color separation and recombination between two reflective liquid crystal on silicon (LCoS) microdisplay panels. For example, see U.S. Pat. No. 6,183,091, U.S. Published Patent Application No. US 2001/0000971, U.S. patent application Ser. No. 10/000,227, and U.S. patent application Ser. No. 10/713,548, all commonly owned with the present disclosure and incorporated herein by reference in their entirety for all purposes. In addition, other patents exist in the field to well known companies, such as Sanyo Electric Co., Ltd., Advanced Digital Optics, Inc., Sony and JVC. In addition, as evidenced in such prior references, the use of plate wire grid PBSs for combining and separating light with isolated panels is also known. However, when employing such PBSs in these systems, the refraction imparted by the thickness and composition of the PBS plate typically results in an “astigmatism” in the final projected image where portions of the light rays are focus on one focal plane while other light rays are focus on one or more other focal panels. Accordingly, what is needed in the art is an architecture for optical display systems that does not suffer from such astigmatism in the projected image.

### BRIEF SUMMARY

Disclosed is a technology that corrects astigmatism introduced by crossing plates, including crossing plates in a two-panel mode. This technology may be used in the context of video projection systems, and in certain embodiments the second plate may be used for combining and splitting beams. In one embodiment, a system is provided for projecting an optical image, where the system includes a lens configured to receive and focus light rays to project the image. The system also includes a first beam splitting/combining plate that refracts light rays passing therethrough, where the refracting creates pluralities of light rays having corresponding optical paths causing each of the pluralities to be focused on corresponding focal planes by the lens. In addition, the system also includes a second beam splitting/combining plate configured to receive the pluralities of rays from the first beam splitting/combining plate, where the second beam splitting/combining plate is oriented with respect to the first beam splitting/combining plate so as to compensate the corresponding optical paths of the pluralities of rays such that each of the pluralities are focused on substantially the same focal plane by the lens.

### BRIEF DESCRIPTION OF THE DRAWINGS

For a more complete understanding of this disclosure, and the advantages of the systems and methods herein, reference is now made to the following descriptions taken in conjunction with the accompanying drawings, in which:

FIG. 1 illustrates a conventional projection system suffering from astigmatism of the projected image;

FIG. 2 illustrates one embodiment of an anastigmatic compensation scheme according to the principles disclosed herein that employs double plates tilted about orthogonal axes, both axes of which are orthogonal to the optic propagation axis of the system; FIG. 3 illustrates one embodiment of a system having an architecture in which the double plate compensation is part of the optical combining architecture; and

FIG. 4 illustrates another embodiment of a projection system incorporating the disclosed principles of astigmatism correction.

### DETAILED DESCRIPTION OF PREFERRED EMBODIMENTS

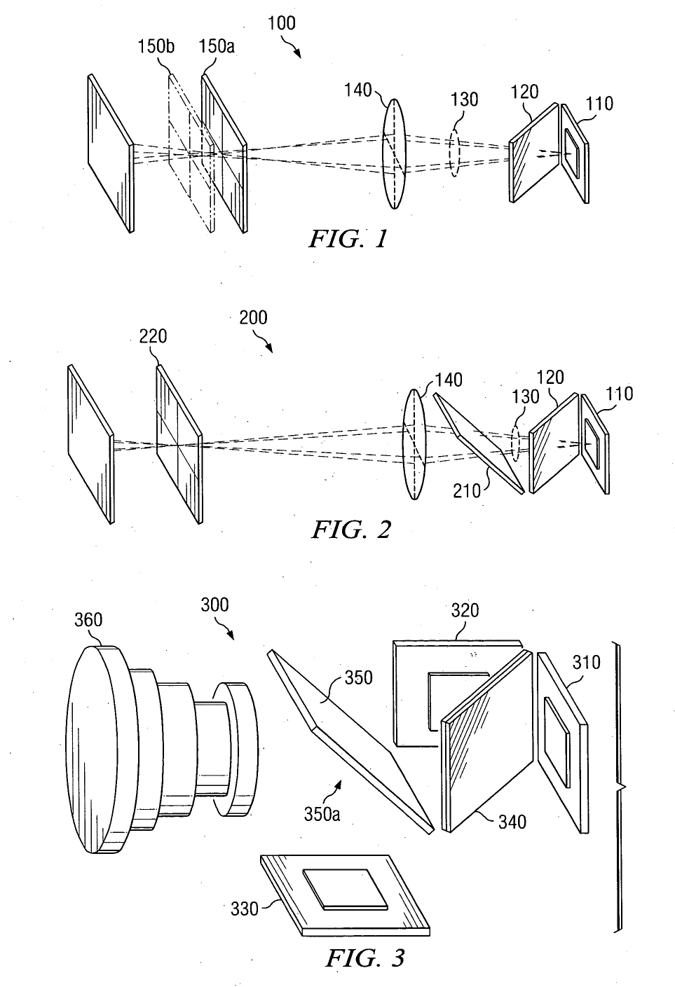

Referring initially to FIG. 1, illustrated is a conventional projection system 100 suffering from astigmatism of the projected image. The illustrated system employs a single color panel 110 and a single tilted plate 120. In such a system, when light rays 130 pass through the plate 120, various rays are refracted so as to travel is different directions. As a result, when the light rays 130 pass through a focusing lens 140, some lights rays 130 are focused on one image focal plane 150a, while other rays 130 are focused on another focal plane 150b. Such an astigmatism results because rays 130 in the vertical and horizontal dimensions are imaged in the different planes 150a, 150b. Thus, in any one plane the image is either uniformly blurred or sharp in only one of the orthogonal dimensions.

Turning now to FIG. 2, illustrated is one embodiment of a projection system 200 employing a double plate solution to the astigmatism problem. As with the system 100 in FIG. 1, this system 200 also includes a color panel 110 and a first plate 120 oriented in a predetermined manner with respect to the color panel 110. Also illustrated are light rays 130 projecting through the plate 120 and through the lens 140.

In accordance with the principles of the present disclosure, the system 200 further includes compensation plate 210 positioned between the plate 120 and the projection lens 140. The additional second plate 210 refracts the light rays 130 in the vertical plane to an optical path similar to the optical path of the light rays in the horizontal plane. Thus, an uncorrected lens 140 is allowed to converge the two sets of rays in a single focal plane. In other words, sharp imaging is possible without the astigmatism.

Among other things, the technology described in this disclosure provides for using a first order astigmatism correction technique of crossing two tilted polarizing beamsplitter (PBS) plates in a reflective microdisplay video projection system. In doing this, the advantages of using plate PBSs in such projection systems are had without penalty with regard to astigmatic correction of any projection optics. This technique and architecture may be used, for example, in systems wherein a single plate PBS is used to split and combine light from two panels. Such systems are attractive from physically compact and cost standpoints. In certain aspects, the correction is adequate for certain color channels, although it may be inadequate or not required for others. Due to the color variation of human eye's imaging performance, certain inadequacies of performance in the optical system become tolerable or acceptable.

Looking now at FIG. 3, illustrated one embodiment of a system 300 having an architecture in which the double plate compensation is part of the optical combining architecture. More specifically, in this embodiment of the system 300 three panels 310, 320, 330. Of course, in other embodiments, the disclosed techniques may be used with any pair of the panels, of course any single panel is also compensated in the illustrated embodiment. Note also the plate 340 that is shared between panels 320 and 310 has its reflecting surface buried. This allows correction for both panels 310, 320 by virtue of the reflected rays from panel 320 passing through the tilted plate between it and the buried reflecting layer. In certain embodiments, this may or may not be necessary since the panel 320 that has light reflected off this compound reflector may not require very good imaging.

In short, in this approach any pair of panels 310, 320 are compensated for astigmatism by the plate beam splitter 340. Note that the reflecting surface 350a of the plate 350 is facing the projection lens 360 and the lower panel 330. For this reason the lower panel 330 imaging path does not need astigmatic compensation. However, as light rays project from either or both panels 310 and 320 and pass through plates 340, the astigmatism in the light rays in introduced. The plane of the compensation plate 350 is rotated about an axis that is orthogonal to that of the plates 340. Moreover, to assist in accurately compensating the astigmatism introduced by the plates 340, the overall thickness of the compensation plate 350 may beneficially be selected to match the thickness of the plates 340. Once compensated, the light rays travel into the projection lens 360, which may now focus all the light rays on the same focal plane.

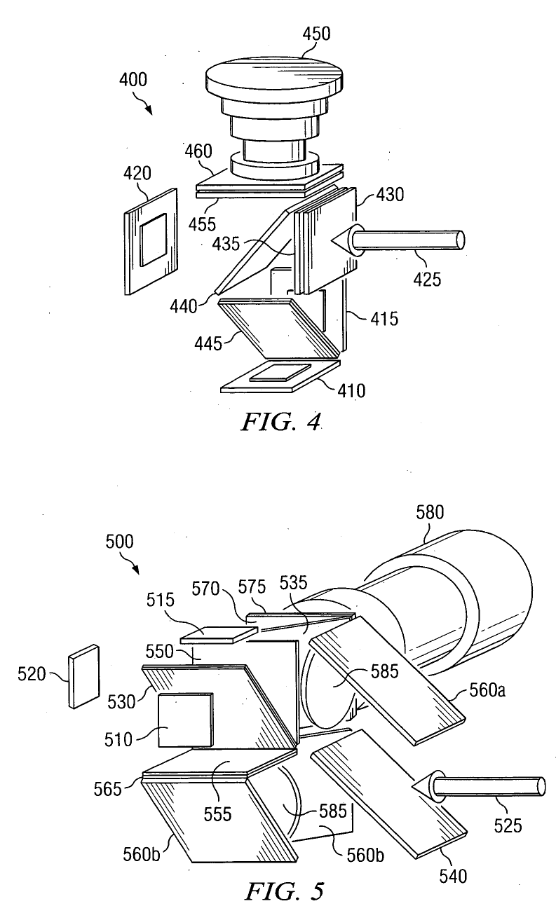

Referring now to FIG. 4, illustrated in another embodiment of a projection system 400 incorporating the disclosed principles of astigmatism correction. The illustrated embodiment is a low cost three-panel architecture having red 410, blue 415, and green 420 panels. This embodiment takes in white light 425, which is passes through a pre-polarizer 430 before being selectively polarized with a ColorSelect® green/magenta filter 435. S-polarized magenta light then reflects off a plate PBS 440 (denoted as a wire grid PBS (WGPBS) in this embodiment) before being split with a polarization preserving dichroic mirror 445. The dichroic mirror 445 is a red/blue mirror for use with the red 410 and blue 415 panels. Reflected light is either of the same polarization, i.e. in their OFF-state, or orthogonal, the ON-state. Similar polarizations get recombined by the dichroic plate, but are then reflected back toward the source by the WGPBS. Orthogonal polarizations are also recombined at the dichroic mirror 445, but pass through the WGPBS 440 and are imaged onto an image plane via a projection lens 450. An output green/magenta ColorSelect® filter 455 and p-polarizer 460 allow transmission of the magenta light.

Green light is left p-polarized after the input G/M filter 435 and is transmitted through the WGPBS 440 toward the green panel 420. In the OFF-state, the panel 420 does not change the green light's polarization state by reflection, which causes most of the light to be transmitted by the WGPBS 440 toward the source. The light that is reflected by the WGPBS 440 gets rotated to s-polarized light by the output G/M filter 455 to be absorbed by the output polarizer 460. In its ON-state the green light becomes s-polarized by reflection by the panel 420 and is then reflected off the WGPBS 440 toward the projection lens 450. The output G/M filter 455 rotates it to p-polarization allowing transmission through the output polarizer 460 where it hits the projection lens 450.

This embodiment is a very low cost embodiment, and potentially high performance, architecture employing the principles disclosed herein. The crossed plates (plate 440 and 445) act to correct the astigmatism as per the concept outlined above, allowing use of WGPBSs 440 that do not need quarter wave or similar geometric compensation. As before, the astigmatism is removed by having the WGPBS 440 rotated orthogonally to the plate 445. The high angle performance of the WGPBS 440 would also allow small panels or larger lamps to be used with the related throughput improvements over conventional PBSs. One downside of the architecture is an increase in optical path length and the ray angles due to the low index of air in the optical path compared this the high index of alternative lead glass prisms. This in turn puts demand on the projection lens design and increases optical component sizes in telecentric systems. One solution, which takes advantage of the angular tolerance of the WGPBS 440 and ColorSelect® filters 435, 460, is to go off-telecentric and use field lenses at the panels 410, 415, 420. In addition, the dichroic coating in this embodiment may be graded in this or other embodiments to avoid or mitigate non-uniformity issues.

Turning finally to FIG. 5, illustrated is an embodiment of a projection system 500 employing two PBS plates (again denoted as WGPBSs), and which would not demand polarization preservation by the dichroic plate(s). As with the system 400 in FIG. 4, this system 500 includes red 510, blue 515, and green 520 panels for processing incoming white light 525. However, this embodiment now employs two WGPBSs 530, 535 to correct any astigmatism problems present in the propagated light rays.

Generally, when using PBSs adjacent all color panels 510, 515, 520 there is a requirement that light cannot enter and exit through the same PBS port. Because of this, the illustrated embodiment provides a little more complicated (but nevertheless low cost) 3D arrangement to illuminate the panels 510, 515, 520. Also, to ensure the same polarization of the red and blue light entering and leaving the shared WGPBS 530, RB ColorSelect® filters 550, 555 are used to sandwich the R/B WGPBS 530, as shown.

This embodiment of the disclosed technique operates first by splitting green from the magenta light via the input dichroic plate 540. A mirrors 560a then direct the green light through a WGPBS 535 toward the green panel 520, while other mirrors 560b direct the magenta light toward a pre-polarizer 565 and RB ColorSelect® filter 555. The RB filter 555 then rotates the polarization of red light relative to the blue allowing separation and recombination with a second, shared WGPBS plate 530. After reflecting off the Red and Blue panels 510, 515, the magenta light is recombined to be either transmitted toward the first WGPBS 535 if the panels 510, 515 have altered the polarization states, or reflected back to the source in the case where the panels 510, 515 are OFF and do not alter polarization. The transmitted light is recombined to be uniform p-polarized by a second RB filter 550 and passes though the first WGPBS 535, an output G/M filter 570, and an output clean-up polarizer 575 so that it may be imaged onto the screen by the projection lens 580. The green light is either projected or not, as discussed with respect to the embodiment shown in FIG. 4.

Also, as mentioned above, the thicknesses of the WGPBSs 530, 535 employed to correct astigmatism will typically be made near equivalent. That is the combined thickness of the PBS substrate and its covering glass plate 530 with the near equivalent to the thickness of the substrate of the PBS plate 535. As for the embodiments in FIGS. 3 and 4 the reflecting surface is sandwiched between its substrate and this cover glass plate to compensate astigmatism for both transmitted and reflected light. In addition, as shown, there are internal lenses 585 that allow off-telecentric illumination, which minimizes component size for any given illumination f/#. This could be extended further to field lenses directly adjacent the panels as described for the first embodiment. Also, for the embodiments in FIGS. 4 and 5, and as stated earlier, the blue port may not require astigmatic compensation. In this case, the reflecting surface of the WGPBS 530 would be facing the blue panel 515. Removing the covering glass plate would act to minimize ghost images on screen from both the red and blue channels.

While various embodiments of projection techniques in accordance with the principles disclosed herein, have been described above, it should be understood that they have been presented by way of example only, and not limitation. Thus, the breadth and scope of the invention(s) should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A system for projecting an optical image, the system comprising:
a lens configured to receive and focus light rays to project the image;
a first beam splitting/combining plate that refracts light rays passing through it, the refracting creating pluralities of light rays having corresponding optical paths causing each of the pluralities to be focused on corresponding focal planes by the lens; and
a second beam splitting/combining plate configured to receive the pluralities of rays from the first beam splitting/combining plate, the second beam splitting/combining plate oriented with respect to the first beam splitting/combining plate so as to compensate the corresponding optical paths of the pluralities of rays such that each of the pluralities are focused on substantially the same focal plane by the lens.
